(19) United States
(12) Patent Application Publication
(10) Pub. No.: US 2011/0320592 A1
(43) Pub. Date: Dec. 29, 2011

(54) METHODS, SYSTEMS, AND COMPUTER READABLE MEDIA FOR CONTENT DELIVERY USING DEEP PACKET INSPECTION

(76) Inventors: Frederick Charles Kemmerer, JR., Hollis, NH (US); Robert E. Denman, Plano, TX (US)

(21) Appl. No.: 13/152,874

(22) Filed: Jun. 3, 2011

Related U.S. Application Data
(60) Provisional application No. 61/358,364, filed on Jun. 24, 2010.

(51) Int. Cl. G06F 15/16

(52) U.S. Cl. 709/224

(57) ABSTRACT

Methods, systems, and computer readable media for content delivery using deep packet inspection are disclosed. According to one method, steps are performed at a packet inspection (PI) module that is distinct from a cache module. The method includes receiving a request for content. The method also includes inspecting the request to obtain information about the content. The method further includes determining, by comparing the obtained information with traffic management policy information based on a dynamically derived content access profile, whether the cache module is to process the request. The method also includes, in response to determining that the cache module is to process the request, sending the request towards the cache module.

### RELATED APPLICATIONS

This application claims the benefit of U.S. Provisional Patent Application Ser. No. 61/358,364 filed Jun. 24, 2010; the disclosure of which is incorporated herein by reference in its entirety.

### TECHNICAL FIELD

The subject matter described herein relates to content delivery in communications network. More specifically, the subject matter relates to methods, systems, and computer readable media for content delivery using deep packet inspection.

### BACKGROUND

Content delivery can result in various expenses for the access provider or Internet server provider (ISP). In particular, infrastructure and peering costs for delivering content to user equipment (UE) can be significant. As such, content delivery systems may minimize transport costs by storing remote content locally. For example, a content delivery system may employ a local cache to store content from remote content sources. In this example, the system may send all requests for content to the local cache. If the local cache has the requested content stored, the local cache may provide the requested content to the requester. Otherwise, the local cache may trigger a remote content source to provide the content to the local cache. The local cache may receive and maintain the content for future requesters.

While conventional content delivery systems with caches can lower delivery costs and speed up transmission and related access times, such systems are subject to finite resources and, as such, only a portion of requested content can be stored locally at a particular time. For example, a cache has finite memory, storage, and processing resources. If the cache is configured to store all content that is requested, the cache's memory or storage will eventually become filled as requests for various content are received. Once the cache's memory or storage is filled, the cache may stop storing newly requested content or must overwrite previously stored content to store the newly requested content. Either caching approach potentially prevents some content from being stored in the cache, thereby requiring that content to be retrieved from a different content source, which may be latency-inducing and incur additional expenses for the access provider.

Content management may be performed to minimize the effects of finite memory or storage resources and ensure only relevant content is cached. Conventional content management determines what content is stored based on preconfigured information, such as uniform resource locators (URLs) for web sites and content servers. For example, conventional content delivery systems may direct that all requests for content at a web site be handled by a local cache. Oftentimes, however, the cache will be unable to store all content that is handled, resulting in undesirable, cached content volatility. Thus, such static content management does not provide sufficient granularity to effectively utilize cache memory and other resources.

Accordingly, in light of these difficulties, a need exists for improved methods, systems, and computer readable media for content delivery using deep packet inspection.

### SUMMARY

Methods, systems, and computer readable media for content delivery using deep packet inspection are disclosed. According to one method, steps are performed at a packet inspection (PI) module that is distinct from a cache module. The method includes receiving a request for content. The method also includes inspecting the request to obtain information about the content. The method further includes determining, by comparing the obtained information with traffic management policy information based on a dynamically derived content access profile, whether the cache module is to process the request. The method also includes, in response to determining that the cache module is to process the request, sending the request towards the cache module.

A system for content delivery is also disclosed. The system includes a packet inspection (PI) module that is distinct from a cache module. The PI module includes a network interface for receiving a request for content. The PI module also includes a content management module for inspecting the request to obtain information about the content, for determining, by comparing the obtained information with traffic management policy information based on a dynamically derived content access profile, whether the cache module is to process the request, and for, in response to determining that the cache module is to process the request, sending the request towards the cache module.

The subject matter described herein may be implemented in hardware, a combination of hardware and software, firmware, or any combination of hardware, software, and firmware. As such, the terms “function” or “module” as used herein refer to hardware, a combination of hardware and software, firmware, or any combination of hardware, software, and firmware for implementing the features described herein. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “deep packet inspection” or “DPI” refers to inspecting or examining one or more portions, such as an application payload portion and various header portions, of a packet.

As used herein, the term “node” refers to a physical computing platform including one or more processors and memory.

As used herein, the term “traffic” refers to one or more packets communicated in a communications network.

As used herein, the term “packet” refers to any data-containing structure for communicating information in a communications network.

As used herein, the term “content” refers to any information that may be provided or requested in a communications network, e.g., text, music, video, audio, pictures, numbers, characters, metadata, and other data.

As used herein, the term “content source” refers to any entity that may provide or store content.

As used herein, the term “subscriber” refers to any user of a communications network, e.g., a customer of a mobile network service provider.

### BRIEF DESCRIPTION OF THE DRAWINGS

The subject matter described herein will now be explained with reference to the accompanying drawings of which:

FIG. 1 is a block diagram illustrating an exemplary network including a content delivery system according to an embodiment of the subject matter described herein;

FIG. 2 is a message flow diagram illustrating content delivery via a cache redirection using a content delivery system according to an embodiment of the subject matter described herein;

FIG. 3 is a message flow diagram illustrating content delivery via a browser-based session with caching triggered by a content delivery system according to an embodiment of the subject matter described herein; and

FIG. 4 is flow chart illustrating an exemplary process for delivering content according to an embodiment of the subject matter described herein.

### DETAILED DESCRIPTION

The subject matter described herein includes methods, systems, and computer readable media for content delivery using deep packet inspection. In one embodiment, a packet inspection (PI) module may enforce policies (e.g., traffic management or redirect policies) based on or derived from one or more content access profiles. The enforced policies may include information for determining how to handle requests for content, e.g., whether to forward requests for content to a cache module that is distinct from the PI module.

As will be discussed further below, content access profiles may include information regarding frequency of access to particular content, volume of traffic associated with delivery of particular content, or other information for determining that the particular content should be cached, e.g., the content may be high demand and caching the content may save valuable network resources. The content access profiles may be generated or updated periodically or aperiodically and may be based on content related and/or user related statistics retrieved from storage or network elements. Using relevant content access profiles, traffic management policies for redirecting content requests for specific, “high runner” content to the cache may be created and/or updated, e.g., by a statistics and/or subscriber manager. For example, high runner or high volume content may be determined based on a function that uses traffic statistics, such as frequency of access, traffic volume required to deliver the content, and content size. The PI module may receive and use such policies in making content management decisions, thereby offloading content management decisions from the cache module. For example, the PI module may determine, using a traffic management policy, particular content (e.g., video A at a popular video sharing site) is cache-preferred (e.g., high demand or “high runner” content). Based on this determination, the PI module may direct content requests for the particular content to a cache module. In response to receiving the content requests, the cache module may store the particular content, if the particular content is not already stored at the cache. Hence, the PI module can direct requests for particular content (e.g., today's top 10 pop music videos) at a content source (e.g., web site, content server) without requiring redirection of requests for all content at the content source (e.g., all videos associated with YouTube). Further, the PI module can offload aspects of content management (e.g., decisions on what content is stored at a cache module) from a cache module. By providing a PI module front-end that uses traffic management policies based on content access profiles for determining how to process and forward requests for content and related traffic, the subject matter described herein can provide more granularity in directing requests for content, more efficient resource usage, and faster overall content delivery to subscribers over conventional solutions.

Reference will now be made in detail to exemplary embodiments of the subject matter described herein, examples of which are illustrated in the accompanying drawings. Wherever possible, the same reference numbers will be used throughout the drawings to refer to the same or like parts:

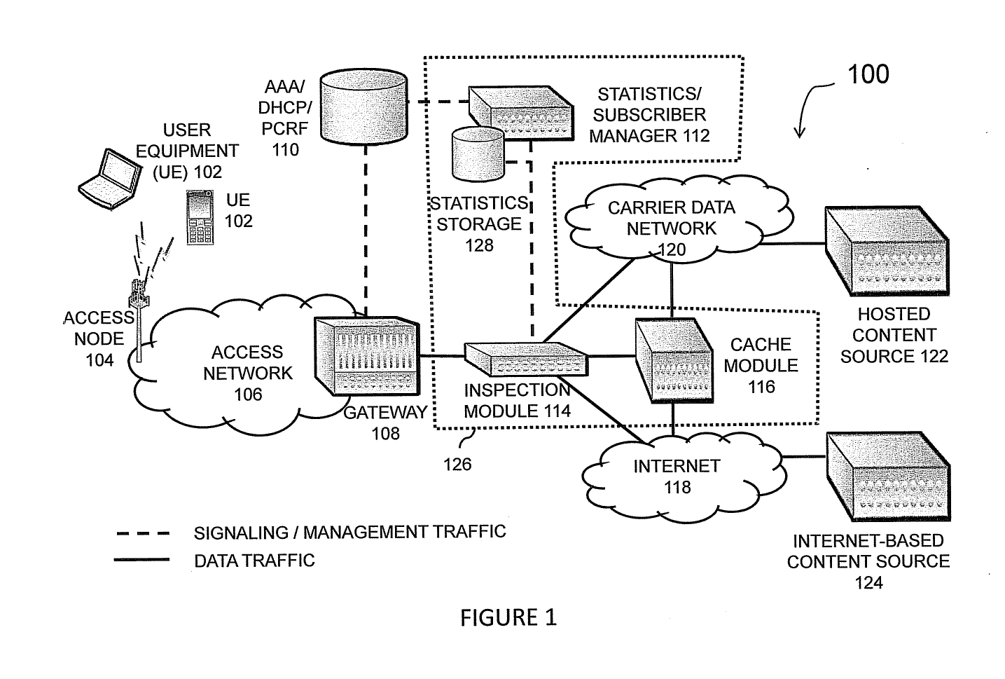

FIG. 1 is a block diagram illustrating an exemplary network including content delivery system according to an embodiment of the subject matter described herein. Referring to FIG. 1, network 100 includes various exemplary components, modules, and/or devices associated with at least one of an access network 106, the Internet 118, and carrier packet data network (PDN) 120. For example, network 100 may include various exemplary components that are involved in content delivery at an access edge, a peering edge, or network aggregation point.

Nodes or elements within the network 100 may communicate various types of traffic, e.g., signaling, management, and user data, using various protocols. While FIG. 1 depicts certain traffic between nodes, it will be appreciated that different or additional traffic may be communicated between nodes.

Access network 106 represents a network for providing mobile data services to user equipment (UE) 102. For example, access network 106 may include a radio access network and mobile packet core network. In this example, the radio access network may represent a wireless or radio access portion (e.g., a Universal Mobile Telecommunications System (UMTS), an Evolved Universal Terrestrial Radio Access Network (e-UTRAN), a Code Division Multiple Access (CDMA), an Evolution Data-Only (EV-DO), a Worldwide Interoperability for Microwave Access (WiMAX), or a global system for mobile communications (GSM) radio access network (RAN)) and the mobile packet core network may represent a core portion of a communications network, such a GPRS or Evolved Packet Core (ePC) network. In another example, access network 106 may include a fixed broadband network and/or a cable network.

UE 102 may represent any device capable of receiving or sending communications using network 100. For example, UE 102 may include a phone, a computer, a tablet computer, a smartphone, a customer premises equipment (CPE), or other device. Access node (AN) 104 represents a functional entity for receiving and/or sending messages to or from UE 102, e.g., using wireless, cable, xDSL, or fiber technology. For example, UE 102 may communicate with a mobile access network via AN 104. In the example, AN 104 may be a base transceiver station (BTS), a node B, an evolved node B, or an access node.

In the embodiment shown in FIG. 1, access network 106 may include a gateway 108 for sending and receiving communications with other networks, such as PDN 120, and Internet 118. In one embodiment, gateway 108 may include at least one of a gateway general packet radio service (GPRS) support node (GGSN), a packet data serving node (PDSN), a home agent (HA), an access-content-aware gateway, or a packet data network (PDN) gateway.

Gateway 108 may communicate with various nodes or elements, such as an authentication, authorization, and accounting (AAA) server, a dynamic host configuration protocol (DHCP) server, and/or a Policy and Charging Rules Function (PCRF) (AAA/DHCP/PCRF 110), and a packet inspection (PI) module 114. In some embodiments, gateway 108 may include additional functionality. For example, PI module 114 may be integrated with or co-located at gateway 108. In this example, gateway 108 with PI functionality may identify particular traffic, such as content requests, and may handle such traffic differently (e.g., redirect content request traffic towards a cache module 116 or provide information about the request traffic to statistics storage 128).

AAA/DHCP/PCRF 110 may represent one or more functional entities for providing subscription-, configuration- and policy-related information (e.g., subscriber profiles) and may authenticate, authorize, or perform configuration or accounting for a subscriber using UE 102. For example, gateway 108 may, in establishing a connection for the user to retrieve web content, query AAA/DHCP/PCRF 110 for a subscriber policy or other information about the subscriber or UE 102. Depending on information received from AAA/DHCP/PCRF 110, gateway 108 may determine whether to allow the connection. AAA/DHCP/PCRF 110 may also communicate with a statistics and/or subscriber (statistics/subscriber) manager 112. Alternatively, the statistics/subscriber manager 112 may passively tap the signaling exchanged between gateway 108 and AAA/DHCP/PCRF 110.

Statistics/subscriber manager 112 may represent one or more functional entities for maintaining subscriber related information and/or traffic statistics. For example, statistics/subscriber manager 112 may represent one or more distinct devices, such as a subscriber manager device for managing subscriber information and a statistics storage device 128 for storing and/or managing traffic statistics. In another example, manager 112 may be a single device capable of performing subscriber management and traffic statistics storage functions.

Statistics/subscriber manager 112 may communicate or interwork with various network components. For example, manager 112 may receive information (e.g., subscriber-related information and traffic statistics) from various entities, such as gateway 108, AAA/DHCP/PCRF 110, statistics storage 128, PI module 114, a home subscriber server, or a third-party module (e.g., a business support system (BSS) or an operations support system (OSS) device). Manager 112 may maintain this information for various purposes, including accounting, policy management, and network traffic management, as well as to associate internet protocol (IP) addresses with specific user identities.

Accordingly, in some embodiments, manager 112 may identify users in network 100 and correlate content requests with identified users. For example, in an embodiment where users opt-in or request PI-based traffic management, manager 112 may tap into or terminate signaling associated with a user (e.g., when the user accesses network 100). For instance, manager 112 may associate a user identifier with an IP address that is assigned to UE 102. Manager 112 may maintain this association for generating user-appropriate content access profiles and/or traffic management policy information for use by PI module 114. Manager 112 may also provide user association information (e.g., binding of user identifiers with associated IP addresses) to PI module 114, such that PI module 114 may provide user-aware functionality, such as traffic statistics that are correlated by user identifiers.

Manager 112 may analyze maintained information to generate profiles and/or policies. For example, manager 112 may include an analyzer module for generating a content access profile. In one embodiment, an analyzer module may be at a node distinct from manager 112, such as PI module 114 or an analyzing node. The analyzer module may request and/or receive information (e.g., subscriber-related information and traffic statistics) from various entities, such as AAA/DHCP/PCRF 110, an OSS device, and statistics storage 128, for generating a content access profile.

In some embodiments, manager 112 or analyzer module may receive subscriber profile information from an OSS device or other module (e.g., AAA/DHCP/PCRF 110). The subscriber profile information may indicate whether a user has subscribed or opted-in to various services, such as a PI-based traffic management service. Using the subscriber profile information, manager 112 or analyzer module may generate content access profiles and/or PI policies that are user-aware and/or subscription-aware. For example, a PI module 114 enforcing a user-aware policy may direct content requests for the same content differently based on whether a user has opted-in to the PI-based traffic management service. In another example, if a user is subscribed to a premium delivery service, a subscription-aware PI policy may direct content requests from the user to a high speed, low latency cache module 116 having the requested content.

A content access profile may include information associated with content, subscribers, and/or resources. For example, a content access profile may include information about particular content (e.g., frequency a YouTube-hosted or Hulu-hosted video is requested or accessed by users in the aggregate, size of the content, and percentage of traffic volume associated with the content in a configurable time period) for determining how the content and associated traffic (e.g., requests for the content) is to be handled. The content access profile may also indicate an amount of network resources used when retrieving the content from an Internet-based content source (e.g., a YouTube video server).

In one embodiment, a content access profile may be used for configuring or updating policies, such as traffic management policies or traffic redirection policies that are installed at and enforced by PI module 114. For example, manager 112 may automatically generate a content access profile for specific content based on various factors, e.g., a configurable time period, a traffic volume amount, a network condition, by network operator request, or other factors. The content access profile may be created using statistics received from PI module 114 or other sources. Based on one or more dynamically derived content access profiles, a PI policy may be generated or updated for deployment to and/or enforcement by PI module 114. For example, analyzer module or other module may generate a PI policy. In another example, a content access profile may be periodically or dynamically sent to PI module 114 for configuring or updating PI policies at PI module 114.

A PI policy may include information indicating high runner content (as determine by one or more content access profiles) is to be cached and/or content requests for high runner content are to be redirected to a cache. In addition to a policy containing redirection information for conveying a request for content to a cache module, additional policies may be installed on PI module 114 with traffic shaping information for rate-limiting, prioritizing, or adapting traffic, and/or adaptation policy information for selecting a content format for delivery to a user.

PI module 114 may represent an entity for inspecting or examining traffic (e.g., one or more packets). PI module 114 may perform deep packet inspection (DPI) of packets relating to content delivery, requests for content, or the content itself. PI module 114 may include one or more network interfaces for receiving packets and functionality for inspecting packets with content requests to obtain information about the content and the subscriber requesting the content.

In some embodiments, PI module 114 may be a stand-alone device or node. For example, PI module 114 may be separate and distinct from cache module 116. In other embodiments, PI module 114 may be integrated with or co-located at various nodes, such as gateway 108 and AN 104.

PI module 114 may inspect traffic for identifying and correlating related packets, e.g., flows or sessions. Such inspection may include analyzing one or more layers of the Open Systems Interconnection (OSI) layer model. For example, PI module 114 may analyze application, presentation, and session layer information, along with lower level information (e.g., information associated with transport, network, or data link), of a request for content. Based on this analysis, PI module 114 may identify particular content that is being requested, identify the UE 102 and associated user that is requesting the content, identify the service provider or carrier that is associated with user, and/or identify the content provider that is associated with the requested content.

PI module 114 may convey obtained information about content requests and/or traffic statistics to various modules. For example, PI module 114 may send traffic statistics to statistics storage 128 and/or statistics/subscriber manager 112. In some embodiments, traffic statistics may be correlated with user identifiers and/or associated IP addresses. In such an embodiment, the user-identifying information or bindings may be provided by manager 112 or other module.

PI module 114 may enforce one or more policies for triggering cache-preferred content to be stored at and/or provided by cache module 116. PI module 114 may allow requests for non-cache-preferred (e.g., low demand or long tail) content to bypass cache module 116 and be routed directly to content sources identified by UE 102, e.g., a hosted content source 122 via network 120 or an Internet-based content source 124 via Internet 118.

PI module 114 may include functionality for monitoring, managing, filtering, redirecting, and/or shaping traffic (e.g., sessions or flows of one or more packets). For example, PI module 114 may enforce traffic-related policies that collect data for statistics, prioritize or meter usage of bandwidth, applications and subscribers, and selectively shape or redirect traffic related to users, applications, or content to provide value-added services, improve the user's quality of experience, and efficiently use network resources.

In one embodiment, PI module 114 may also enforce a policy for performing load balancing. For example, PI module 114 may use a load-balancing policy for choosing between available content sources. For example, if plural cache modules 116 have the requested content, PI module 114 may load balance requests for the content among cache modules 116.

In one embodiment, PI module 114 may provide information to cache module 116 for making content management related decisions. For example, UE 102 may sequentially initiate multiple content requests over the same Transmission Control Protocol (TCP) connection for distinct content at the same Internet-based content source 124. In one embodiment, PI module 114 may be configured to select a redirection policy based on the initial content request only. In this embodiment, PI module 114 may apply a redirection policy to redirect to cache module 116 all content requests to Internet-based content source 124, and the policy may also dictate modifying the packet of each request so as to signal to cache module 116 whether or not each specifically requested content should be cached.

In another embodiment (not shown in FIG. 1), the analyzer module or manager 112 may provide the cache-preferred content list directly to cache module 116 for indicating which particular content should be stored, maintained, or provided by cache module 116. In one embodiment, information may be provided or made available to cache module 116 periodically, dynamically, or upon request. For example, a content list indicating current high demand content on a given network may be generated and provided to cache module 116 every week. In a second example, a content list may be generated and provided to cache module 116 in response to a network operator request. In a third example, a content list may be generated and provided to cache module 116 in response to an increased network load.

Cache module 116 represents one or more functional entities for storing and providing content. In one embodiment, cache module 116 may be distinct from PI module 114. For example, cache module 116 and PI module 114 may be implemented by different processors and/or on different computing platforms. Cache module 116 may include a network interface for receiving a request for content, and another network interface for requesting content that has not already been stored from hosted content source 122 or Internet-based content source 124. Cache module 116 may also include functionality (e.g., a cache management module or content retrieval module) for determining whether cache module 116 has stored the requested content or should request it from hosted content source 122 or Internet-based content source 124. If content is retrieved from hosted content source 122 or Internet-based content source 124, the cache management functionality may determine whether the retrieved content should be stored. In response to determining that cache module 116 is to provide content (e.g., in response to receiving a content request), cache module 116 may initiate steps for retrieving the content from its storage. For example, regardless of whether requested content has already been stored or is retrieved from hosted content source 122 or Internet-based content source 124, cache module 116 may send the obtained content towards the user. In one embodiment, content management may be offloaded to PI module 114. For example, PI module 114 may determine content that is to be stored at and/or provided by cache module 116.

Content delivery system 126 may include PI module 114, manager 112, statistics storage 128, and/or cache module 116. In one embodiment, system 126 may be responsible for handling requests for content and associated traffic. System 126 may be implemented on a single platform or across multiple platforms. For example, system 126 or portions thereof may be located at various locations within network 100, e.g., peering edges, access edges, and network aggregation points, for retrieving and delivering content to UE 102. In another embodiment, system 126 could also be located within access network 106. It will be appreciated that system may also include various other modules, components, or nodes. For example, system 126 may include a plurality of cache modules 116, and other modules for adapting content or shaping traffic, e.g., a content adaptation module and a traffic shaping module.

Hosted content source 122 and Internet-based content source 124 represent one or more entities for maintaining or providing content via various networks. In one embodiment, hosted content source 122 may be a server or other node connected to or accessible via carrier network 120. For example, hosted content source 122 may provide content (e.g., music and videos) associated with a carrier-related service, such as Verizon Wireless' V Cast service.

In one embodiment, Internet-based content source 124 may be a server or other node connected to or accessible via Internet 118. For example, Internet-based content source 124 may provide content (e.g., music and videos) associated with a web site or content server, such as YouTube, Netflix, or Hulu.

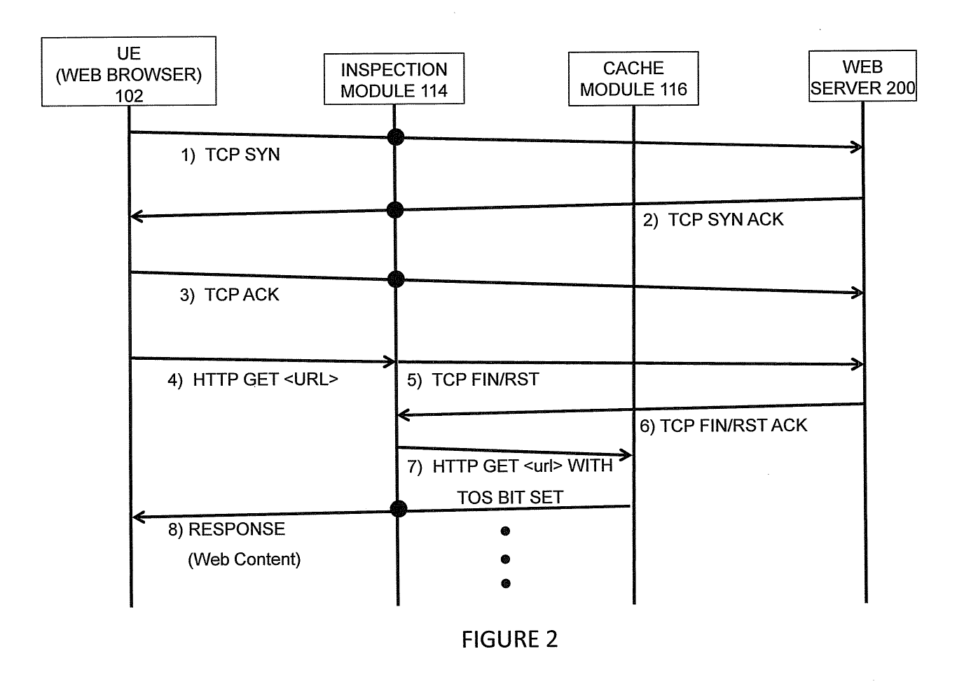

FIG. 2 is a message flow diagram illustrating content delivery via a cache redirection using a content delivery system according to an embodiment of the subject matter described herein. In particular, the flow diagram of FIG. 2 depicts various nodes of FIG. 1 involved in a content delivery scenario using a TCP protocol and an HTTP protocol.

While FIG. 2 depicts TCP and HTTP protocols, it will be appreciated that various protocols could be used in content delivery and that the nodes and modules depicted may include functionality (e.g., physical network interfaces and additional modules) for receiving and/or processing messages of various protocols. For example, the nodes and modules of FIG. 2 may include one or more network interfaces configured for receiving or sending messages using at least one of an Internet protocol (IP), a transmission control protocol (TCP), a hypertext transfer protocol (http), a session initiation protocol (SIP), a real time transport protocol (RTP), a real time streaming protocol (RTSP), a real time transport control protocol (RTCP), and a peer-to-peer (P2P) protocol.

Referring to FIG. 2, in step 1, UE 102 sends a TCP synchronize (SYN) message to web server 200. For example, a web browser running on UE 102 may send the TCP SYN message for initiating a request for a TCP session with web server 200. In one embodiment, web server 200 may be Internet-based content source 124. In a second embodiment, web server 200 may be hosted content source 122.

The TCP SYN message may be received at PI module 114. PI module 114 may inspect the message and determine how to process or handle (e.g., relay, drop, delay, or redirect) the message. For example, PI module 114 may allow the message to continue towards an original destination or may direct the message towards a new destination. The message may traverse PI module 114 to web server 200.

In step 2, web server 200 sends a TCP SYN acknowledgement (ACK) message towards UE 102 in response to receiving the TCP SYN message of step 1. The TCP SYN ACK message may be received at PI module 114. PI module 114 may inspect the message and determine how to handle the message. The message may traverse PI module 114 to UE 102.

In step 3, UE 102 sends a TCP ACK message towards web server 200 in response to receiving the TCP SYN ACK message. The TCP ACK message may be received at PI module 114. PI module 114 may inspect the message and determine how to handle the message. The message may traverse PI module 114 to web server 200. In one embodiment, sending and receiving a TCP ACK is the last step of a TCP handshake for establishing a TCP session.

In step 4, UE 102 sends an HTTP GET message towards web server 200 for requesting content, e.g., a video or song from a website, using a URL or other content and/or location identifier. The HTTP GET message may be sent after the TCP session is established. The HTTP GET message may be received at PI module 114. PI module 114 may inspect the message and determine how to handle the message.

As stated above, PI policies, such as redirection policies, may be derived from or based on content access profiles of high runner or frequently accessed content. For example, a redirection policy based on such profiles may direct requests for high runner or frequently accessed content to the best available content source for providing the requested content in the shortest amount of time, e.g., cache 116.

In one embodiment, a direction or redirection policy may be used for requesting and/or providing content based on various other information associated with content access profiles. For example, a redirection policy may be configured based on operating cost or resource usage. In this example, some content may be stored at content sources in carrier network 120, e.g., content source 122. Retrieving content stored in the carrier network may be cheaper and/or may use fewer resources than retrieving content from cache 116. Thus, in this example, the redirection policy may direct requests to hosted content source 122 for content stored therein and may direct requests for other content to cache 116. In another example, a redirection policy may direct request to cache 116 for subscribers that opt-in to receiving content optimization service or that subscribe to a particular tier of service. In another example, the redirection policy may direct requests of opted-in subscribers to cache 116, while directing requests of other subscribers to Internet-accessible sources, e.g., content source 124.

PI module 114 may inspect the HTTP GET message and determines that the request and/or associated traffic is to be redirected to cache module 116. In step 5, PI module 114 sends or initiates sending a TCP finish (FIN) or TCP reset (RST) message toward web server 200 for closing or aborting the TCP session between UE 102 and web server 200. For example, PI module 114 may generate a TCP FIN or RST message such that it appears to originate from UE 102.

In step 6, web server 200 sends a TCP FIN or RST ACK message towards UE 102 in response to receiving the TCP FIN or RST message of step 5. In one embodiment, after receiving a TCP FIN or RST message and sending an ACK message, web server 200 may no longer send messages towards UE 102. Further, after receiving a TCP FIN or RST message and sending an ACK message, web server 200 may discard received messages that appear to originate from UE 102.

The ACK message may be received at PI module 114. PI module 114 may inspect the message and determine how to handle the message. As depicted, PI module 114 may discard or otherwise prevent the message from being forwarded towards UE 102. In one embodiment, UE 102 may be unaware of PI module 114 actions and/or unaware of the closed status of the TCP session between itself and web server 200.

In step 7, PI module 114 sends an HTTP GET message or other message towards cache module 116 for requesting content. In one embodiment, a TCP session may be established between PI module 114 and cache module 116 before an HTTP GET message is sent to cache module 116. In one embodiment, step 7 and step 5 may be concurrent actions. In another embodiment, step 5 may occur before or after step 7. In one example, step 7 could occur in response to receiving an ACK message of step 6. In a second example, step 7 could occur without receiving an ACK message of step 6. In a third example, step 7 may occur before step 5.

In one embodiment, the HTTP GET message of step 7 may be generated based on the HTTP GET message of step 4. For example, a generated HTTP GET message may include header information for directing associated response traffic (e.g., packets including content) to PI module 114. In another embodiment, PI module 114 may alter the HTTP GET message originating from UE 102 before sending the altered HTTP GET message towards cache module 116. For example, the HTTP GET message may be altered to include header information for directing associated response traffic (e.g., packets including content) to PI module 114.

In one embodiment, the HTTP GET message of step 7 may include a flag or other indicator for indicating to cache module 116 how to process or handle the message. For example, an indicator may include a particular parameter or parameter value. The HTTP GET message may include a particular Type of Service (TOS) parameter value (e.g., a bit value of 1) for indicating that the requested content should be served by and stored by cache module 116. In this embodiment, indicating that the request for content should be stored by cache module 116 may be referred to as having a TOS bit set.

Likewise, the HTTP GET message may include a different Type of Service (TOS) parameter value (e.g., a bit value of 0) for indicating that the request for content should be served but not stored by cache module 116. In this embodiment, indicating that the request for content should not be stored by cache module 116 may be referred to as not having a TOS bit set.

In step 8, cache module 116 sends or triggers another node to send a response message or messages towards UE 102 in response to receiving the HTTP GET message of step 7. For example, cache module 116 may receive an http GET message not having a TOS bit set. Cache module 116 may inspect the message and determine that the request for content indicates that cache module 116 is not to store the content. In response to determining that cache module 116 is not to store the content, cache module 116 may direct or proxy the request to a content source that is distinct from cache module 116. In this example, one or more response messages that include content may be provided to UE 102 via traversing cache module 116 and/or PI module 114.

Cache module 116 may receive an http GET message having a TOS bit set. Cache module 116 may inspect the message and determine that the request for content has an indicator for indicating that cache module 116 is to provide the content. In response to determining that the request for content includes the indicator, cache module 116 may initiate steps for retrieving and sending the content towards UE 102. If cache module 116 has already stored the requested content, then cache module 116 may retrieve the content from its storage and sends the content towards UE 102. Otherwise, cache module 116 may proxy the request toward web server 200, after having established a TCP session with said server 200. Cache module 116 may send the resulting content as it is received towards UE 102.

In some embodiments, cache module 116 may retrieve content prior to receiving the http GET message. For example, in response to a prior content request, cache module 116 may have already retrieved the requested content from web server 200 and stored the content for future deliveries. In this example, when a current content requests arrives, cache module 116 retrieves the content from its storage and sends the content towards UE 102.

The one or more response messages (e.g., HTTP 200 OK messages) containing the requested content may be received at PI module 114. PI module 114 may inspect the one or more messages and determine how to handle them. For example, PI module 114 may allow messages including requested content to continue towards an original destination or may direct the messages towards a new destination.

In one embodiment, PI module 114 may use a policy configured for shaping or rate-limiting or prioritizing traffic. For example, a traffic-shaping policy may be used to reduce or increase the rate of packets being sent to or received from UE 102 and/or other nodes, such as cache 116, content source 122, and content source 124.

In one embodiment, a traffic shaping policy may be configured for streaming content or other content. For example, a policy may be used in providing an amount of content at an initial rate for initial viewing or playing content at UE 102 and, after providing this amount of content, the policy may be used to reduce the rate of new content delivered. In this embodiment, if a subscriber decides to stop or abort a content transfer, it is possible that the content is not fully transferred before the abort operation is performed. As such, network resources may be saved in that resources are not wasted transferring content that is no longer wanted. As such, the policy is able to save resources for scenarios where content download or retrieval is aborted before content can be completely viewed, played, or otherwise consumed.

The one or more response messages may traverse PI module 114 to UE 102. UE 102 may view, play, store, or otherwise consume the content.

It will be appreciated that the steps illustrated above are illustrative and that additional and/or different steps may occur based on various factors, e.g., network setup and configuration of system 126. Further, the steps illustrated above may occur differently in some embodiments.

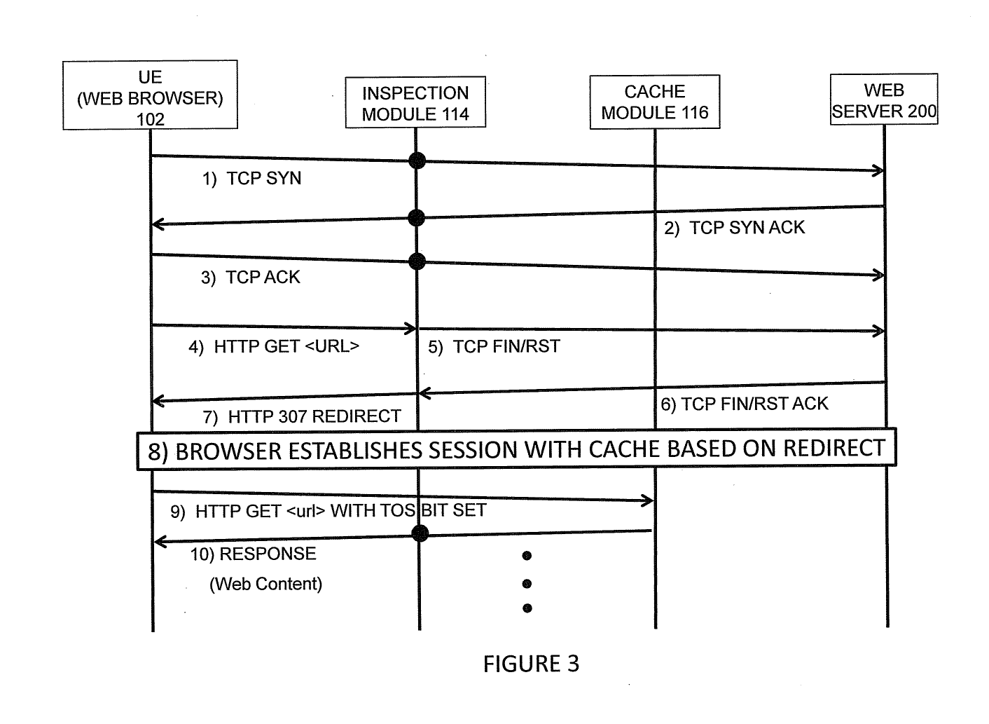

FIG. 3 is a message flow diagram illustrating content delivery via a browser-based session with caching triggered by a content delivery system according to an embodiment of the subject matter described herein. In the embodiment shown in FIG. 3, PI module 114 may be configured to trigger a UE-based redirection to cache module 116 in response to receiving a HTTP GET message.

Referring to FIG. 3, steps 1-3 are essentially the same as those in FIG. 2 for establishing a TCP session. For example, a TCP handshake, including a TCP SYN message, a TCP SYN ACK message, and an ACK message, may be performed between UE 102 and web server 200.

In step 4, UE 102 sends an HTTP GET message towards web server 200 for requesting content, e.g., a video or song from a website, using a URL or other content and/or location identifier. The HTTP GET message may be sent after the TCP session is established. The HTTP GET message may be received at PI module 114. PI module 114 may inspect the message and determine how to handle the message.

As stated above, a direction or redirection policy may direct requests for high runner or frequently accessed content to the best available content source for providing the requested content in the shortest amount of time, e.g., cache module 116. In one embodiment, PI module 114 may perform actions for triggering UE 102 to direct requests for content to a content source, e.g., cache module 116.

PI module 114 may inspect the HTTP GET message and determine that the request and/or associated traffic are to be redirected to cache module 116. In step 5, PI module 114 sends or initiates sending a TCP finish (FIN) or TCP reset (RST) message toward web server 200. In one embodiment, PI module 114 sends or initiates sending the TCP FIN or RST message for closing or aborting the TCP session between UE 102 and web server 200. For example, PI module 114 may generate a TCP FIN or RST message such that it appears to originate from UE 102.

In step 6, web server 200 sends a TCP FIN or RST ACK message towards UE 102 in response to receiving the TCP FIN or RST message of step 5. In one embodiment, after receiving a TCP FIN or RST message and sending an ACK message, web server 200 may no longer send messages towards UE 102. Further, after receiving a TCP FIN or RST message and sending an ACK message, web server 200 may discard received messages that appear to originate from UE 102.

The ACK message may be received at PI module 114. PI module 114 may inspect the message and determine how to handle the message. As depicted, PI module 114 may discard or otherwise prevent the message from being forwarded towards UE 102. In one embodiment, UE 102 may be unaware of PI module 114 actions and/or unaware of the closed status of the TCP session between itself and web server 200.

In step 7, PI module 114 sends an HTTP 307 Temporary Redirect message for informing UE 102 to redirect the request for content to a different destination or address. For example, an HTTP 307 Temporary Redirect message may be sent to UE 102 indicating that the request for content should be temporarily redirected to cache module 116.

In step 8, UE 102 establishes a session with cache module 116 in response to receiving the HTTP 307 Temporary Redirect message of step 7. For example, a TCP handshake, including a TCP SYN message, a TCP SYN ACK message, and an ACK message, may be performed between UE 102 and cache module 116.

In step 9, UE 102 sends an HTTP GET message towards cache module 116 for requesting content, e.g., a video or song from a website, using a URL or other content and/or location identifier. In one embodiment, an HTTP GET message is sent after a TCP session is established. In one embodiment, the HTTP GET message may be received at PI module 114. PI module 114 may inspect the message and determine how to handle the message.

In step 10, cache module 116 sends or triggers another node to send a response message or messages towards UE 102 in response to receiving the HTTP GET message of step 9. For example, cache module 116 may receive an http GET message. If cache module 116 has already stored the requested content, then cache module 116 retrieves said content from its storage and sends the content towards UE 102; otherwise, cache module 116 proxies the request toward web server 200, after having established a TCP session with said server 200, and both stores resulting content as it is received (for future content requests) and relays the content to UE 102.

The one or more response messages containing the requested content may be received at PI module 114. PI module 114 may inspect the one or more messages and determine how to handle them. For example, PI module 114 may rate limit the packets carrying requested content to UE 102.

The one or more response messages may traverse PI module 114 to UE 102. UE 102 may view, play, store, or otherwise consume the content.

It will be appreciated that the steps illustrated above are illustrative and that additional and/or different steps may occur based on various factors, e.g., network setup and configuration of system 126. Further, the steps illustrated above may occur differently in some embodiments. For example, step 7 and step 5 may be concurrent actions. In another example, step 5 may occur before or after step 7.

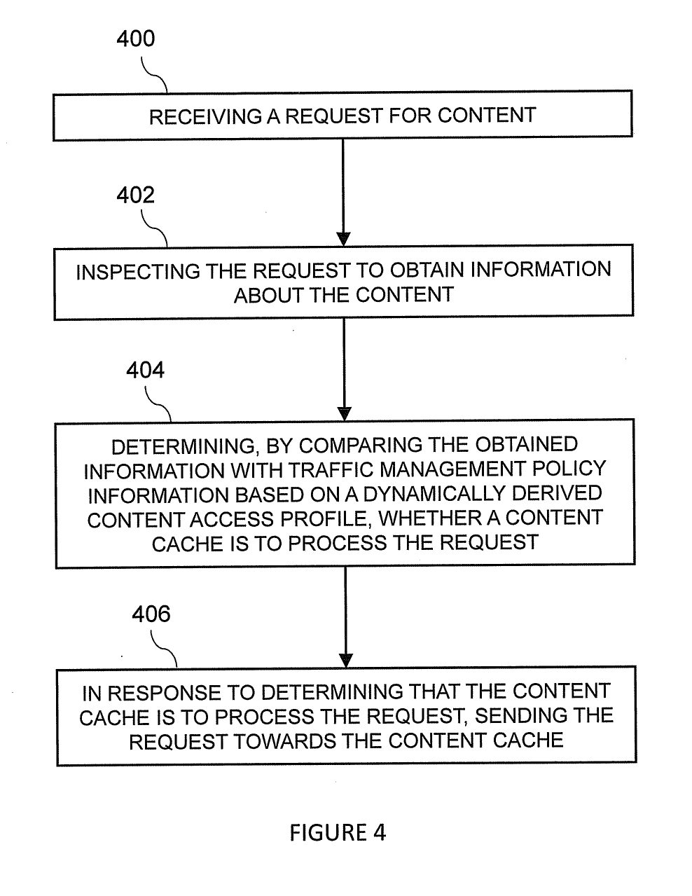

FIG. 4 is flow content chart illustrating an exemplary process for delivering content according to an embodiment of the subject matter described herein. In one embodiment, the exemplary process may occur at or be performed by a packet inspection (PI) module distinct from a cache module. In one embodiment, the exemplary process may occur at or be performed by an analyzer module distinct from a cache module.

Referring to FIG. 4, in step 400, a request for content and that originates from a subscriber may be received. For example, an HTTP GET message or another request message originating from UE 102 may be received at PI module 114.

In step 402, the request may be inspected to obtain information about the content. For example, PI module 114 may inspect the request and obtain a content identifier (e.g., a URL) for identifying the requested content. PI module 114 may also obtained additional information, such as a user identifier, a device type, and/or a location identifier, and may save the obtained information in statistics storage 128. An analyzer module (e.g., at a statistics/subscriber manager 112) may subsequently use stored information (along with other information) in creating content access profiles and/or associated PI policies, such as traffic management policies that indicate whether requests for specific content are to be directed to cache module 116. Said content access profiles and/or associated PI policies may be based on or reflect high frequency of recent accesses by aggregate users to and/or high traffic volumes associated with specific content at content sources.

In step 404, it may be determined, by comparing the obtained information with traffic management policy information based on a dynamically derived content access profile, whether a cache module is to process the request. For example, PI module 114 may use obtained information (e.g., a content identifier) to match appropriate policy information. The policy information may indicated that the requested content is high demand content or otherwise cache-preferred and, as such, may include a redirection instruction for redirecting the content request to cache module 116.

In one embodiment, a dynamically derived content access profile may be generated using content-related information received from at least one of traffic statistics storage, a home subscriber server (HSS), an authentication, authorization, or accounting (AAA) server, a subscriber manager, a billing server, a content source, a user device, a customer premises equipment, an access-content-aware gateway, cache module 116, and PI module 114. For example, prior to step 400, other content request messages may have been processed and statistics generated. An analyzer module may have used these statistics in generating content access profiles and/or related policies currently being enforced by PI module 114.

In one embodiment, a content access profile and/or related policies includes information regarding at least one of content, one or more requesters, a content source, cache module 116, access or request frequency of content, size of content, traffic volume associated with delivering content, and location of content.

In step 406, in response to determining that the cache module is to process the request, the request may be sent towards the cache module. For example, PI module 114 may redirect the request towards cache module 116. In a second example, PI module 114 may alter the request or generate a new request based on the original request before sending the message towards cache module 116.

It will be appreciated that the exemplary process described above is illustrative for a content request, additional and/or different steps may occur. Further, it will be appreciated that the exemplary process or a similar process may be performed multiple times. For example, in a given network, thousands or millions of users may be attempting to download content every few minutes. PI module 114 may receive such requests and generate statistics, which may then be used to generate new content access profiles and PI policies. Accordingly, in one embodiment, an aspect of the present subject matter described herein may perform dynamic content and cache management, e.g., based on statistics associated with access to specific content.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for content delivery, the method comprising:
at a packet inspection (PI) module distinct from a cache module:
receiving a request for content;
inspecting the request to obtain information about the content;
determining, by comparing the obtained information with traffic management policy information based on a dynamically derived content access profile, whether the cache module is to process the request; and
in response to determining that the cache module is to process the request, sending the request towards the cache module.

2. The method of claim 1 wherein a request, subsequently received from the user, for different content is handled by the cache module regardless of the traffic management policy information.

3. The method of claim 2 wherein requests sent to the cache module include request handling information for indicating how the requests should be handled.

4. The method of claim 3 wherein the request handling information includes information for serving the content or both serving the content and, when the content is not already stored, storing the content.

5. The method of claim 1 wherein the content access profile is based on statistics associated with recent accesses of the content from a plurality of users.

6. The method of claim 5 wherein the plurality of users consists of users that have opted-in to a content optimization service.

7. The method of claim 5 wherein the statistics include at least one of frequency of access to the content at one or more content sources in a designated time period and traffic volume associated with access to the content at one or more content sources in a designated time period.

8. The method of claim 1 wherein the PI module facilitates offloading traffic from a carrier data network or from an Internet peering point.

9. The method claim 1 wherein, in response to determining that the cache module is not to process the request, sending the request for content towards a content source distinct from the cache module and receiving, at the PI module and from the content source, requested content, wherein the request and the requested content do not traverse the cache module.

10. The method of claim 1 wherein determining whether the cache module is to process the request includes determining, based on the traffic management policy information, that the requested content is cache-preferred content and should be stored at the cache module.

11. The method of claim 10 wherein determining whether the cache module is to process the request includes determining whether the user requesting the content has opted-in to a content optimization service.

12. The method of claim 10 wherein determining that the requested content is cache-preferred content is based on a function that uses statistics associated with at least one of frequency of access to the content, traffic volume associated with the content, and content size.

13. The method of claim 1 wherein the content access profile includes information regarding at least one of the content, a content source, access or request frequency of the content, size of the content, traffic volume associated with delivering the content, and location of the content.

14. The method of claim 1 wherein the content access profile is generated using content-related information received from at least one of traffic statistics storage, a home subscriber server (HSS), an authentication, authorization, or accounting (AAA) server, a subscriber manager, a billing server, a content source, a user device, a customer premises equipment, an access-content-aware gateway, the cache module, and the PI module.

15. The method of claim 1 wherein the content access profile is used to create, update, or delete the traffic management policy information.

16. The method of claim 15 wherein updated traffic management policy information is periodically provided to the PI module.

17. The method of claim 1 wherein the traffic management policy information includes redirection information for conveying a request for content to a cache module.

18. The method of claim 1 comprising:
at a cache module distinct from the PI module:
receiving the request for content; and
initiating steps for retrieving and sending the content towards the user.

19. The method of claim 18 wherein initiating steps for retrieving and sending the content towards the user includes:
determining whether the content is stored at the cache module,
in response to determining that the content is not stored at the cache module, retrieving the content from a content source distinct from the cache module;
storing the content at the cache module; and
sending the content towards the user.

20. A system for content delivery, the system comprising:
a packet inspection (PI) module that is distinct from a cache module, the PI module comprising:
a network interface for receiving a request for content; and
a content management module for inspecting the request to obtain information about the content, for determining, by comparing the obtained information with traffic management policy information based on a dynamically derived content access profile, whether the cache module is to process the request and for, in response to determining that the cache module is to process the request, initiating sending the request towards the cache module.

21. The system of claim 20 wherein the content management module is configured to send a request, subsequently received from the user, for different content to the cache module regardless of the traffic management policy information.

22. The system of claim 21 wherein the content management module is configured to include request handling information for indicating how the cache module should handle the requests.

23. The system of claim 22 wherein the request handling information includes information for serving the content or both serving and, when the content is not already stored, storing the content.

24. The system of claim 20 wherein the content access profile is based on statistics associated with recent accesses of the content from a plurality of users.

25. The system of claim 24 wherein the plurality of users consists of users that have opted-in to a content optimization service.

26. The system of claim 24 wherein the statistics include at least one of frequency of access to the content at one or more content sources in a designated time period and traffic volume associated with access to the content at one or more content sources in a designated time period.

27. The system of claim 20 wherein the PI module facilitates offloading traffic from a carrier data network or from an Internet peering point.

28. The system of claim 20 wherein the PI module is integrated with a gateway.

29. The system of claim 20 wherein the content management module is configured to send, in response to determining that the cache module is not to process the request, the request for content towards a content source distinct from the cache module and receive, at the PI module and from the content source, requested content, wherein the request and the requested content do not traverse the cache module.

30. The system of claim 20 wherein the content management module is configured to determine, based on the traffic management policy information, that the requested content is cache-preferred content and should be stored at the cache module.

31. The system of claim 20 wherein determining whether the cache module is to process the request includes determining whether the user requesting the content has opted-in to a content optimization service.

32. The system of claim 30 wherein determining that the requested content is cache-preferred content is based on a function that uses statistics associated with at least one of frequency of access to the content, traffic volume associated with the content, and content size.

33. The system of claim 20 wherein an analyzer module is configured to generate the content access profile using content-related information received from at least one of traffic statistics storage, a home subscriber server (HSS), an authentication, authorization, or accounting (AAA) server, a subscriber manager, a billing server, a content source, a user device, a customer premises equipment, an access-content-aware gateway, the cache module, and the PI module.

34. The system of claim 33 wherein the analyzer module is configured to use the content access profile to create, update, or delete the traffic management policy information.

35. The system of claim 34 wherein the analyzer module is configured to periodically provide updated traffic management policy information to the PI module.

36. The system of claim 20 wherein the traffic management policy information includes redirection information for conveying a request for content to a cache module.

37. The system of claim 20 comprising:
a cache module distinct from the PI module, the cache module comprising:
a network interface for receiving a request for content; and
a content retrieval module for initiating steps retrieving and sending the content towards the user.

38. The system of claim 37 wherein initiating steps for retrieving and sending the content towards the user includes:
determining whether the content is stored at the cache module,
in response to determining that the content is not stored at the cache module, retrieving the content from a content source distinct from the cache module;
storing the content at the cache module; and
sending the content towards the user.

39. A computer readable medium comprising computer executable instructions embodied in a non-transitory computer readable medium and when executed by a processor of a computer performs steps comprising:
at a packet inspection (PI) module distinct from a cache module:
receiving a request for content;
inspecting the request to obtain information about the content;
determining, by comparing the obtained information with traffic management policy information based on a dynamically derived content access profile, whether the cache module is to process the request; and
in response to determining that the cache module is to process the request, sending the request towards the cache module.
